(19) United States
(12) Patent Application Publication
(10) Pub. No.: US 2019/0031833 A1
(43) Pub. Date: Jan. 31, 2019

(54) METHOD FOR PRODUCING POLYORGANOSILOXANES HAVING AMINO GROUPS

(71) Applicant: Wacker Chemie AG, Munich (DE)

(72) Inventors: Alfred POPP, Unterhaching (DE); Oliver SCHAEFER, Burghausen (DE)

(73) Assignee: Wacker Chemie AG, Munich (DE)

(21) Appl. No.: 16/073,717

(22) PCT Filed: Jan. 27, 2017
(86) PCT No.: PCT/EP2017/051730

§ 371 Date: Jul. 27, 2018

(30) Foreign Application Priority Data
Feb. 3, 2016 (DE) 10 2016 201 633.4

(51) Int. Cl. C08G 77/26; C08G 77/06

(52) U.S. Cl. CPC C08G 77/26; C08G 77/06

(57) ABSTRACT

Organopolysiloxanes having amino groups are prepared by reacting wherein
(A) silanes of the formula

R¹—O—SiR₂—O—R¹ (I)

with
(B) silanes of the formula

(R³₂N)—X—SiR⁴₂—O—R² (II)

and
(C) water.

### CROSS REFERENCE TO RELATED APPLICATIONS

This application is the U.S. National Phase of PCT Appln. No. PCT/EP2017/051730 filed Jan. 27, 2017, which claims priority to German Application No. 10 2016 201 633.4 filed Feb. 3, 2016, the disclosures of which are incorporated in their entirety by reference herein.

### BACKGROUND OF THE INVENTION

### 1. Field of the Invention

The invention relates to a process for preparing organopolysiloxanes having amino groups by hydrolysis of organyloxysilanes.

### 2. Description of the Related Art

Processes for preparing organosilicon compounds having amino groups are already known. U.S. Pat. No. 5,461,134 describes an equilibration process for preparing aminoalkyl-terminated siloxanes having chain lengths of more than 70 silicon atoms. Anhydrous tetramethylammonium hydroxide aminopropyldimethylsilanolate serves as a catalyst.

CN 102775613 describes a process for preparing α,ω-bis(aminopropyl)polydimethylsiloxane using anhydrous cyclic siloxane and a siliconate catalyst which is prepared separately by action of alkali on cyclosiloxane.

US 2011301374 describes a process for preparing organopolysiloxanes having amino groups, characterized in that organosilicon compounds which have amino groups and Si-bonded hydroxyl groups and are obtainable by equilibration of substantially linear organopolysiloxanes having terminal SiC-bonded amino groups with substantially linear organopolysiloxanes and/or cyclosiloxanes having terminal Si-bonded hydroxyl groups are reacted with silazanes in the presence of equilibration catalysts.

US 2002049296, US 2007197757 and US 2008009590 describe processes for preparing amino-functional siloxanes, in which hydroxy-functionalized organosiloxanes are reacted with a cyclic silazane (see, for example, US 2002042491).

US 2015112092 describes a process for preparing amino-functional polyorganosiloxanes, in which organosiloxanes containing Si—OH groups are reacted with at least stoichiometric amounts, based on the Si—OH groups, of monoalkoxy(aminoalkyl)silanes in the presence of at least one acid as catalyst.

US 2008234441 and US 2011301254 describe processes for preparing organically modified siloxanes by catalysed reaction of siloxanes having at least one SiH group with a compound having a double bond, where the compound having the double bond can also have, inter alia, amino groups as a radical.

It is common to all these processes that they use linear or cyclic disiloxanes, oligosiloxanes or polymeric siloxanes which in turn have to be built up from the monomeric silanes in a sometimes complicated fashion, as a raw material. In addition, the formation of cyclic siloxanes, which in turn have to be separated in a complicated manner, cannot be avoided in the abovementioned equilibration processes. Another disadvantage of these processes is the fact that either additional catalysts are used whose deactivation and removal is sometimes difficult, or else that the processes have to be carried out at elevated temperatures, which in the presence of amino groups always incurs the risk of discolouration of the product.

### SUMMARY OF THE INVENTION

The invention provides a process for preparing organopolysiloxanes having amino groups, wherein

(A) silanes of the general formula

R¹—O—SiR₂—O—R¹ (I)

are reacted with

(B) silanes of the general formula

(R³₂N)—X—SiR⁴₂—O—R² (II)

and

(C) water,

where

the radicals R can be identical or different and are monovalent, optionally substituted hydrocarbon radicals in which nonadjacent methylene units can be replaced by —O— or —NH-groups,

R¹ and R² can, independently of one another, be identical or different and are monovalent, optionally substituted hydrocarbon radicals,

the radicals R³ can be identical or different and are each a monovalent, optionally substituted hydrocarbon radical or hydrogen atom,

the radicals R⁴ can be identical or different and are monovalent, optionally substituted hydrocarbon radicals and

X is an alkylene radical which has from 1 to 20 carbon atoms and in which nonadjacent methylene units can be replaced by —O— or —NH— groups.

### DETAILED DESCRIPTION OF THE PREFERRED EMBODIMENTS

For the purposes of the present invention, the term organopolysiloxanes encompasses polymeric, oligomeric and also dimeric siloxanes.

Organopolysiloxanes which have amino groups and have the general formula

(R³₂N)—X—SiR⁴₂—O—[SiR₂—O—]ₙ—SiR⁴₂—X—(NR³₂) (III)

where R, R³, R⁴ and X have one of the abovementioned meanings and n is 0 or an integer greater than 0, are preferably obtained in the process of the invention.

Examples of hydrocarbon radical R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl and methylcyclohexyl radicals; alkenyl radicals such as the vinyl, 1-propenyl and 2-propenyl radicals; aryl radicals such as the phenyl, naphthyl, anthryl and phenanthryl radicals; alkaryl radicals such as o-, m-, p-tolyl radicals, xylyl radicals, and ethylphenyl radicals; and aralkyl radicals such as the benzyl radical, and the α- and β-phenylethyl radicals.

Examples of substituted hydrocarbon radicals R are haloalkyl radicals such as the 3,3,3-trifluoro-n-propyl radical, the 2,2,2,2′,2′,2′-hexafluoroisopropyl radical and the heptafluoroisopropyl radical, haloaryl radicals such as the o-, m- and p-chlorophenyl radicals, alkyl radicals having ether oxygens, e.g. alkoxyalkyl radicals such as the 2-methoxyethyl radical, and also alkyl radicals having amino groups, e.g. aminoalkyleneaminoalkyl radicals such as the N-(2-aminoethyl)-3-aminopropyl radical or the 3-aminopropyl radical.

The radicals R are preferably hydrocarbon radicals which are optionally substituted by amino groups and have from 1 to 20 carbon atoms, more preferably the methyl, ethyl, phenyl or 3-aminopropyl radicals, in particular the methyl radical.

Examples of hydrocarbon radicals R¹ and R² are the radicals indicated above for radical R.

Examples of substituted hydrocarbon radicals R¹ and R² are haloalkyl radicals such as the 3,3,3-trifluoro-n-propyl radical, the 2,2,2,2′,2′,2′-hexafluoroisopropyl radical and the heptafluoroisopropyl radical, haloaryl radicals such as the o-, m- and p-chlorophenyl radicals and also alkyl radicals having ether oxygens, e.g. alkoxyalkyl radicals such as the 2-methoxyethyl radical.

Preference is given to the radicals R¹ and R² being, independently of one another, hydrocarbon radicals having from 1 to 20 carbon atoms, more preferably the methyl, ethyl or phenyl radicals, in particular the methyl or ethyl radical.

Examples of hydrocarbon radicals R³ are the radicals indicated above for radical R.

Examples of substituted hydrocarbon radicals R³ are haloalkyl radicals such as the 3,3,3-trifluoro-n-propyl radical, the 2,2,2,2′,2′,2′-hexafluoroisopropyl radical and the heptafluoroisopropyl radical, haloaryl radicals such as the o-, m- and p-chlorophenyl radical, alkyl radicals having ether oxygens, e.g., alkoxyalkyl radicals such as the 2-methoxyethyl radical, and also alkyl radicals having amino groups, e.g. aminoalkyleneaminoalkyl radicals such as the N-(2-aminoethyl)-3-aminopropyl radical.

The radical R³ is preferably a hydrogen atom or a hydrocarbon radical which is optionally substituted by amino groups and has from 1 to 20 carbon atoms, more preferably hydrogen.

Examples of hydrocarbon radicals R⁴ are the radicals indicated above for radical R.

Examples of substituted hydrocarbon radicals R⁴ are haloalkyl radicals such as the 3,3,3-trifluoro-n-propyl radical, the 2,2,2,2′,2′,2′-hexafluoroisopropyl radical and the heptafluoroisopropyl radical, haloaryl radicals such as the o-, m- and p-chlorophenyl radicals and also alkyl radicals having ether oxygens, e.g. alkoxyalkyl radicals such as the 2-methoxyethyl radical.

The hydrocarbon radical R⁴ is preferably a hydrocarbon radical having from 1 to 20 carbon atoms, more preferably the methyl, ethyl or phenyl radicals, in particular the methyl radical.

X is preferably an alkylene radical having from 1 to 10 carbon atoms, more preferably the methylene or n-propylene radical, in particular the n-propylene radical.

The process of the invention has the advantage that the chain length of the organopolysiloxanes having amino groups and thus the molecular weight distribution, i.e. preferably the desired range for index n in formula (III), can be set in a targeted manner according to the required property profile, which is carried out, in particular, via the selected molar ratio of the components (I) and (II).

Index n is preferably an integer from 1 to 10,000, more preferably from 1 to 100, and in particular from 1 to 10.

Examples of silanes of the formula (I) are dimethoxydimethylsilane, diethoxydimethylsilane, dimethoxymethylphenylsilane, dimethoxydiphenylsilane, 3-aminopropylmethyldimethoxysilane, 3-aminopropylmethyldiethoxysilane, N-(2-aminoethyl)-3-aminopropylmethyldimethoxysilane and N-(2-aminoethyl)-3-aminopropylmethyldiethoxysilane, with dimethoxydimethylsilane, 3-aminopropylmethyldimethoxysilane or N-(2-aminoethyl)-3-aminopropylmethyldiethoxysilane being preferred and dimethoxydimethylsilane being particularly preferred.

Examples of silanes of the formula (II) are 3-aminopropyldimethylmethoxysilane, 3-aminopropyldimethylethoxysilane, N-(2-aminoethyl)-3-aminopropyldimethylmethoxysilane and N-(2-aminoethyl)-3-aminopropyldimethylethoxysilane, with 3-aminopropyldimethylmethoxysilane or 3-aminopropyldimethylethoxysilane being preferred and 3-aminopropydimethylmethoxysilane being particularly preferred.

The silanes of the formulae (I) and (II) are commercial products or can be prepared by methods customary in organosilicon chemistry.

Examples of water (C) used according to the invention are natural waters, e.g. rainwater, groundwater, spring water, river water, and seawater, chemical waters, e.g. deionized water, distilled or (multiply) distilled water, waters for medical or pharmaceutical purposes, e.g. purified water (Aqua purificata; Pharm. Eur. 3), Aqua deionisata, Aqua destillata, Aqua bidestillata, Aqua ad injectionam or Aqua conservata, mains water according to the German mains water regulations, and mineral waters, with the water (C) preferably being mains water.

In the process of the invention, the molar ratio of component (B) to component (A) is preferably in the range from 1:100,000 to 100,000:1, more preferably in the range from 1:100 to 50:1, and in particular in the range from 1:10 to 10:1.

In the process of the invention, the reaction is preferably carried out with mixing. Here, the mixing methods known to a person skilled in the art can be employed. For example, mixing can be effected by stirring.

The contacting of the components (A) and (B) with water (C) can be carried out by all methods known to those skilled in the art. Examples which may be mentioned are mixing stirrers for a batch mode of operation and static mixers for a continuous mode of operation. In the process of the invention, a mixture of the components (A) and (B) is preferably produced before contacting. The mixture of the components (A) and (B) can then be stirred or shaken with water (C) in order to ensure particularly good distribution of the constituents.

The process of the invention can be carried out continuously, batchwise or semicontinuously.

A preferred embodiment of the process of the invention is continuous contacting by passing the alkoxysilanes of the formulae (I) and (II) and water through a reaction tube in which static mixers can optionally also be present.

The molar ratio of the components (A) and (B) to water (C) can be selected in a targeted manner by a person skilled in the art with a view to the desired properties of the end product. Water (C) is preferably used at least stoichiometrically based on all hydrolysable organyloxy groups present in the reaction mixture. Particular preference is given to using water (C) in a molar excess based on all hydrolysable organyloxy groups present, with the excess water being able to be removed by methods known to those skilled in the art, e.g. distillation or phase separation, after the reaction according to the invention. The molar ratio of the sum of the hydrolysable groups, in particular the sum of the hydrolysable groups of the components (A) and (B), to water is preferably in the range from 2:1 to 1:100, more preferably in the range from 1:1 to 1:10, most preferably in the range from 1:1 to 1:5.

If desired, the process of the invention can also be carried out in the presence of a solvent (D) which is inert towards the reaction participants, but this is not preferred. Examples of such solvents are hydrocarbons and halohydrocarbons which are liquid at 20° C. and 1013 mbar, e.g. benzene, toluene, xylene, methylene chloride or petroleum ether.

In addition to the components (A), (B) and (C) and optionally (D), it is possible to use further components such as partial hydrolysates of the silanes of the formula (I) in the process of the invention, but this is not preferred. If partial hydrolysates of the silanes of the formula (I) are present in the process of the invention, in particular as a result of productional handling, the amounts are preferably not more than 10% by weight, more preferably not more than 5% by weight, in each case based on the silane of formula (I) used.

If partial hydrolysates are present in the process of the invention, these preferably have up to 6 silicon atoms.

In the process of the invention, preference is given to no further components being used in addition to the components (A), (B) and (C) and optionally (D) and optionally partial hydrolysates.

The components used in the process of the invention can each be one type of such a component or else a mixture of at least two types of a respective component.

The process of the invention can be carried out in the presence or absence of protective gas, for example nitrogen or argon, with preferance being given to carrying out the process under protective gas, in particular under nitrogen.

The process of the invention is preferably carried out at the pressure of the surrounding atmosphere, i.e. at from 900 to 1100 mbar. However, if desired or necessary, the process of the invention can also be carried out at higher pressures, e.g. from 1100 to 5000 mbar, which can, for example, be the case as a result of the pressure buildup in a loop reactor, or at lower pressures, e.g. from 0.1 to 900 mbar, which can be desirable in order to maintain a relatively low temperature.

The process of the invention is preferably carried out at temperatures in the range from 0° to 200° C., more preferably from 20° to 120° C., and in particular from 20° to 80° C.

In a preferred embodiment, the alcohol liberated during the reaction is removed from the reaction mixture during or after the reaction. The removal is preferably carried out by distillation, for example by distillation under reduced pressure. The distillation techniques known to those skilled in the art, for example equilibrium distillation by means of a column, short path distillation or thin film evaporation, can be used for this purpose. Depending on the type of alcohol, the removal can be effected in pure form or as azeotrope with water. Furthermore, the removal of the alcohol can be carried out by separation of the water phase from the siloxane phase by simple phase separation, which can optionally be improved by coalescers.

Undesirable compounds formed in the reaction, for example cyclosiloxanes, can, if required, be removed by all methods known to those skilled in the art. Thus, undesirable low molecular weight compounds can be removed in a simple manner by thermal removal. The thermal removal can be carried out continuously or batchwise. This removal is preferably carried out continuously. The continuous removal is particularly preferably carried out by means of a short path evaporator or thin film evaporator. The removal conditions necessary (temperature, pressure, residence time) are determined by the properties of the desired target product.

In addition, the partial hydrolysates which are optionally present can, if required, be removed by all methods known to those skilled in the art or be converted into the desired target product, for example by condensation.

The organopolysiloxanes having amino groups which are prepared according to the invention are preferably transparent, colourless to slightly coloured, low-viscosity oils.

The organopolysiloxanes prepared according to the invention preferably have a viscosity at 25° C. of less than 500 mm²/s, more preferably from 1 to 100 mm²/s, and most preferably from 4 to 50 mm²/s.

The desired amine number (AN) of the product prepared according to the invention can advantageously be set by suitable selection of the components (A) and (B). The amine numbers of the organopolysiloxanes having amino groups which have been prepared according to the invention are preferably in the range from 0.1 mg KOH/g to 455 mg KOH/g, more preferably in the range from 9 mg KOH/g to 450 mg KOH/g, and in particular in the range from 100 mg KOH/g to 400 mg KOH/g.

The amine number indicates the number of milligrams of potassium hydroxide which is equivalent to the amine content of one gram of substance.

The aminosiloxanes prepared according to the invention can be used for all purposes for which aminosiloxanes have also been used hitherto.

The process of the invention has the advantage that it is very simple to carry out and the chain length can be set in a targeted manner.

Furthermore, the process of the invention has the advantage that it gives very reproducible product compositions.

The process of the invention has the advantage that readily available industrial raw materials can be used.

A further advantage of the process of the invention is the preferably short reaction times under variable reaction conditions.

A further advantage of the process of the invention is that no catalysts have to be added and subsequently have to be laboriously separated off after the reaction or possibly remain in the product.

The process of the invention has the advantage that the molecular weight distribution of the organopolysiloxanes is reproducible in a constant manner.

In the following examples, all parts stated are, unless indicated otherwise, by weight. Unless indicated otherwise, the following examples are carried out at the pressure of the surrounding atmosphere, i.e. at about 1000 hPa, and at room temperature, i.e. about 20° C., or a temperature which is established on combining the reactants at room temperature without additional heating or cooling. All viscosities reported in the examples are at a temperature of 25° C.

In the following examples, all work was carried out under nitrogen as protective gas.

### Example 1

150 g of water were placed in a 1000 ml three-neck round-bottom flask having an internal thermometer, mechanical stirrer, dropping funnel and protective gas inlet at 25° C. A mixture of 352.9 g of 3-aminopropyldimethylmethoxysilane and 144 g of dimethoxydimethylsilane is added dropwise to the water at such a rate that the internal temperature does not exceed 50° C. The mixture is, after cooling to 25° C., subsequently stirred at this temperature for 12 hours and then freed of the volatile constituents methanol and water under reduced pressure (20 mbar) at 100° C.

This gives 388 g of a fluid oil analogous to the formula (III) having the following composition determined by gas chromatography (column parameters: AGILENT DB-5, 25 m, 0.32 mm, 0.52 μm; injector: HP6890 Front Injector; detector: TCD)

| | |
|---|---|
| n = 0 | 43.2% |
| n = 1 | 25.6% |
| n = 2 | 12.8% |
| n = 3 | 6.4% |
| n = 4 | 3.1% |
| n = 5 | 1.5% |
| n = 6 | 0.6% |
| n = 7 | 0.3% |
| n = 8 | 0.1% |

and the following parameters:

| Viscosity | (DIN 51562-1) | 5.86 mm²/s |
|---|---|---|
| Amine number | (DIN 53176) | 338 mg KOH/g |
| Hazen colour number | (DIN EN ISO 6271) | 18 |

### Example 2

130 g of water were placed in a 1000 ml three-neck round-bottom flask having an internal thermometer, mechanical stirrer, dropping funnel and protective gas inlet at 25° C. A mixture of 176.5 g of 3-aminopropyldimethylmethoxysilane and 144 g of dimethoxydimethylsilane is added dropwise to the water at such a rate that the internal temperature does not exceed 50° C. The mixture is, after cooling to 25° C., subsequently stirred at this temperature for 12 hours and then freed of the volatile constituents methanol and water under reduced pressure (20 mbar) at 100° C. This gives 232 g of a fluid oil analogous to the formula (III) having the following composition determined by gas chromatography (column parameters: AGILENT DB-5, 25 m, 0.32 mm, 0.52 μm; injector: HP6890 Front Injector; detector: TCD)

| | |
|---|---|
| n = 0 | 28.1% |
| n = 1 | 21.6% |
| n = 2 | 15.1% |
| n = 3 | 10.3% |
| n = 4 | 6.8% |
| n = 5 | 4.6% |
| n = 6 | 2.9% |
| n = 7 | 1.8% |
| n = 8 | 1.1% |

and the following parameters:

| Viscosity | (DIN 51562-1) | 7.04 mm²/s |
|---|---|---|
| Amine number | (DIN 53176) | 286 mg KOH/g |
| Hazen colour number | (DIN EN ISO 6271) | 33 |

### Example 3

100 g of water were placed in a 1000 ml three-neck round-bottom flask having an internal thermometer, mechanical stirrer, dropping funnel and protective gas inlet at 25° C. A mixture of 88.2 g of 3-aminopropyldimethylmethoxysilane and 144 g of dimethoxydimethylsilane is added dropwise to the water at such a rate that the internal temperature does not exceed 50° C. The mixture is, after cooling to 25° C., subsequently stirred at this temperature for 12 hours and then freed of the volatile constituents methanol and water under reduced pressure (20 mbar) at 100° C. This gives 154 g of a fluid oil analogous to the formula (III) having the following composition determined by gas chromatography (column parameters: AGILENT DB-5, 25 m, 0.32 mm, 0.52 μm; injector: HP6890 Front Injector; detector: TCD)

| | |
|---|---|
| n = 0 | 16.8% |
| n = 1 | 15.8% |
| n = 2 | 13.1% |
| n = 3 | 10.8% |
| n = 4 | 8.6% |
| n = 5 | 6.9% |
| n = 6 | 5.4% |
| n = 7 | 4.5% |
| n = 8 | 4.4% |

and the following parameters:

| Viscosity | (DIN 51562-1) | 8.95 mm²/s |
|---|---|---|
| Amine number | (DIN 53176) | 214 mg KOH/g |
| Hazen colour number | (DIN EN ISO 6271) | 20 |

### Example 4

100 g of water were placed in a 1000 ml three-neck round-bottom flask having an internal thermometer, mechanical stirrer, dropping funnel and protective gas inlet at 25° C. A mixture of 231 g of 3-aminopropyldimethylmethoxysilane and 150 g of 3-aminopropylmethyldimethoxysilane is added dropwise to the water at such a rate that the internal temperature does not exceed 50° C. The mixture is, after cooling to 25° C., subsequently stirred at this temperature for 12 hours and then freed of the volatile constituents methanol and water under reduced pressure (20 mbar) at 100° C. This gives 283 g of a fluid oil having the following parameters:

| Viscosity | (DIN 51562-1) | 16 mm²/s |
|---|---|---|
| Amine number | (DIN 53176) | 458 mg KOH/g |
| Hazen colour number | (DIN EN ISO 6271) | 32 |

1.-5. (canceled)

6. A process for preparing organopolysiloxanes having amino groups, comprising:
(A) reacting silanes of the formula
R¹—O—SiR₂—O—R¹ (I)
with
(B) silanes of the formula
(R³₂N)—X—SiR⁴₂—O—R² (II)
and
(C) water,
where
the radicals R are identical or different and are monovalent, optionally substituted hydrocarbon radicals in which nonadjacent methylene units are optionally replaced by —O— or —NH— groups,
the radicals R¹ and R² are, independently of one another, identical or different and are monovalent, optionally substituted hydrocarbon radicals,
the radicals R³ are identical or different and are each a monovalent, optionally substituted hydrocarbon radical or hydrogen,
the radicals R⁴ are identical or different and are monovalent, optionally substituted hydrocarbon radicals, and
X is an alkylene radical which has from 1 to 20 carbon atoms and in which nonadjacent methylene units are optionally replaced by —O— or —NH— groups.

7. The process of claim 6, wherein radical R³ is hydrogen.

8. The process of claim 6, wherein the molar ratio of component (B) to component (A) is in the range from 1:100,000 to 100,000:1.

9. The process of claim 7, wherein the molar ratio of component (B) to component (A) is in the range from 1:100,000 to 100,000:1.

10. The process of claim 6, wherein the molar ratio of the sum of hydrolysable groups to water is in the range from 1:1 to 1:10.

11. The process of claim 7, wherein the molar ratio of the sum of hydrolysable groups to water is in the range from 1:1 to 1:10.

12. The process of claim 8, wherein the molar ratio of the sum of hydrolysable groups to water is in the range from 1:1 to 1:10.

13. The process of claim 10, wherein the molar ratio of the sum of hydrolysable groups to water is in the range from 1:1 to 1:10.

14. The process of claim 6, which is carried out under protective gas.

15. The process of claim 7, which is carried out under protective gas.
